(19) United States
(12) Patent Application Publication
(10) Pub. No.: US 2017/0011634 A1
(43) Pub. Date: Jan. 12, 2017

(54) METHOD FOR AIR-TO-GROUND IFF

(71) Applicant: BAE Systems Information and Electronic Systems Integration Inc., Nashua, NH (US)

(72) Inventors: David C. RINGLEN, Coram, NY (US); Ralph CASSARA, Massapequa, NY (US); Gianfranco BONANOME, Wantagh, NY (US); Scott M. POLIKOFF, Long Beach, NY (US)

(21) Appl. No.: 14/826,723

(22) Filed: Aug. 14, 2015

Related U.S. Application Data
(60) Provisional application No. 62/037,186, filed on Aug. 14, 2014.

(51) Int. Cl. G08G 5/00; B64D 45/00

(52) U.S. Cl. CPC G08G 5/0013; B64D 45/00

(57) ABSTRACT

A friend identification method includes steps of (a) targeting a specific ground location, (b) triggering an onboard Mark XIIA Mode 5 transponder, (c) issuing a reverse Mode 5 message to a responder, (d) receiving the reverse Mode 5 message at the responder, (e) decrypting the reverse Mode 5 message, and (f) responding to the reverse Mode 5 message if the specific ground location is within a predetermined radius from the responder.

This application claims benefit of provisional application No. 62/037186, filed Aug. 14, 2014.

### BACKGROUND OF THE INVENTION

1. Field of the Invention

This invention relates to air to ground communications and more specifically, identification friend or foe systems.

2. Brief Description of Related Art.

For Air Traffic Control (ATC) purposes, civil and military aircraft are required to be fitted with Identify Friend or Foe (IFF) transponders. These transponders reply automatically, with information such as height, speed, aircraft identification code, when they receive a Radio Frequency (RF) request from a ground station—usually located at airports.

In times of conflict this identity reporting is used to prevent fratricide and to aid friendly assets in gaining a picture or awareness of the battle space. In order to prevent enemy forces from exploiting this identity reporting, the interrogation signals are coded or, in the case of more modern systems, encrypted.

A transponder is also required to satisfy civil air traffic control requirements; in this case there are no requirements for coding or encryption other than that the transponder replies with the identity of the aircraft and its current altitude. Military IFF transponders are capable of operating in the civil ATC modes, An emergency mode is also provided which will enable the transponder to act as a distress beacon in the event of pilot ejection or similar emergencies.

A transponder comprises a transmitter/receiver unit, upper and lower transmit/receive antennas and a control unit, as exemplified in FIG. 1 of the accompanying drawings. By international accord, they operate on a transmit frequency band centered on 1090 MHz and a receive frequency band centered on 1030 MHz, and in each case the bandwidth is normally less than 10 MHz.

The military purpose of IFF is identification of friendly aircraft by the use of identification codes on the transmission and reply. In this case, called IFF ‘Interrogation’, an aircraft can be requested by either a ground station, land/sea vehicle or another aircraft fitted with an Interrogator to reply to a coded request for identification. Only friendly aircraft who know the code of the day can provide the correct response to the Interrogation.

There is currently no interoperable air-to-ground friend identification method.

### DEFINITIONS

The meanings of various acronyms and technical terms, as used in this document, are as follows:

IFF stands for Identify Friend or Foe. It is the standard system used by the western world (NATO+friends) to securely identify friendly aircraft, The IFF system consists of an “interrogator” which send out a signal (typically from the ground) and a transponder (typically in an aircraft) which responds with a special signal to identify that it is a friend.

ATC stands for Air Traffic Control. This is the process that military or civilian authorities coordinate the flow of aircraft. One of the tools used for Air traffic Control are transmissions similar to IFF, but are not secure.

RF stands for Radio Frequency. This refers to signals that are transmitted through the air as Radio Frequency signals.

“Waveform” typically describes the frequency and pattern of the over the air transmission.

Mark XIIA is the most modern system of IFF. This system includes a variety of different signals that can be sent between the ground and aircraft in order to identify the aircraft. These different signals are called “Modes”. Mark XIIA includes Modes 1,2,3, and C which are not secure and Mode 4 & Mode 5 that are secure. Modes 3 & C are also shared with civilian uses for air traffic control.

Mode 5 is new mode of operation that is protected by a strong cryptographic algorithm. Mode 5 and the entire Mark XIIA system is defined by a NATO requirements document called STANAG 4193. There are also US specific requirements for Mark XIIA.

APX-123 is formally referred to as the “AN/APX-123”, which is the standard transponder for the US Army & Navy, and is installed in many types of aircraft for those 2 services. It is colloquially referred to as the CXP or “Common Transponder”. The APX-123 is built by BAE Systems in Greenlawn, N.Y.

Reverse Mode 5 is the topic of the patent. Reverse Mode 5 refers to a method of using the Mode 5 signals in reverse (the aircraft transmits first and the equipment on the ground responds). The purpose of Reverse Mode 5 is to use existing equipment already installed on every military aircraft in order to identify friendly targets on the ground before weapons are deployed. Regular Mode 5 is used to reduce fratricide of ground systems shooting friend aircraft down. Reverse Mode 5 is used to prevent aircraft from harming friendly forces on the ground.

Level 2 is sub-function of Mode 5. It allows for an aircraft to securely transmit its current GPS position, that only friendly forces can decode. Reverse Mode 5 utilizes Mode 5 Level 2 to identify a point on the ground that is the center of the damage zone.

In the drawing: RM5 stands for Reverse Mode 5

RM5XP is the Reverse Mode 5 capable transponder. This device continues to perform the function of a standard transponder while also implementing Reverse Mode 5.

CXP C & S refers to the common transponder's (APX-123) control and status data. Every aircraft with a transponder has a method to change basic settings and receive health status. The APX-123 transfers this data over a type of serial bus we refer to as Control and Status.

### SUMMARY OF THE INVENTION

Wherefore, it is an object of the present invention to overcome the above mentioned shortcomings and drawbacks associated with the prior art illumination apparatus, systems and techniques.

Reverse IFF, using Mark XIIA Mode 5 (Reverse Mode 5) is primarily designed for close air support (CAS) aircraft to prevent fratricide engagements when operating with ground vehicles and, if equipped, dismounted forces. The Reverse Mode 5-capable transponder uses the existing APX-123 architecture and interfaces and modifies it to include the ability to transmit and receive Reverse Mode 5 waveforms, Reverse Mode 5 provides a low cost, NATO interoperable, autonomous air-to-ground identification and fratricide prevention capability using a robust and mature waveform.

This invention provides an improved friend identification method, comprising steps of targeting a specific ground location, triggering an onboard Mark XIIA Mode 5 transponder, issuing a Reverse Mode 5 message to a responder, receiving the Reverse Mode 5 message at responder, decrypting the Reverse Mode 5 message, and responding to the Reverse Mode 5 message if the specific ground location is within a predetermined radius from the responder.

### BRIEF DESCRIPTION OF THE DRAWINGS

The accompanying drawing, which is incorporated in and constitutes a part of the specification, illustrates an embodiment of the invention and together with the general description of the invention given above and the detailed description of the drawings given below, serve to explain the principles of the invention. The invention will now be described, by way of example, with reference to the accompanying drawing in which:

FIG. 1 is a depiction of the improved system.

### DETAILED DESCRIPTION OF THE INVENTION

The present invention will be understood by reference to the following detailed description, which should be read in conjunction with the appended drawing. It is to be appreciated that the following detailed description of the embodiment is by way of example only and is not meant to limit, in any way, the scope of the present invention.

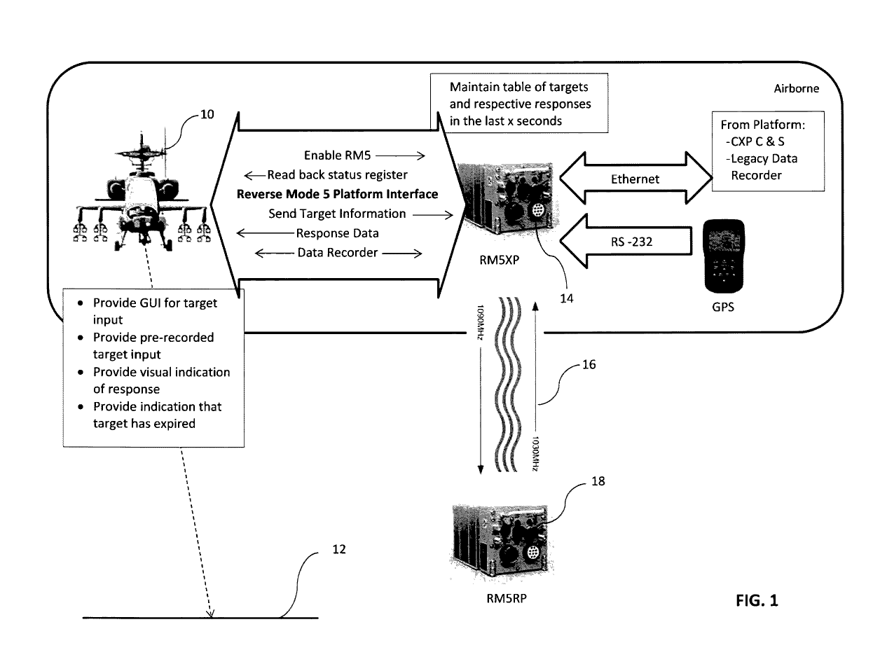

As shown diagrammatically in FIG. 1, operation of the Reverse Mode 5 capability begins when an aircraft 10, targeting a specific ground location 12, triggers an onboard Mark XIIA Mode 5 transponder 14 to issue a Mode 5 Level 2 Target Message 16.

The Reverse Mode 5 Target Message (“interrogation”) contains the attack coordinates, the weapon's effects radius (effective fragmentation radius) and the platform's identification number.

On the ground, at least one Reverse Mode 5 Responder 18 (Reverse Mode 5 receivers equipped on ground vehicles and/or dismounted soldiers) decodes, decrypts and authenticates the Target Messages and, using its own position data, determines whether it lies within the effects radius, measured from the position of the attack coordinates.

If a Responder determines that it is within the effects radius, it replies by generating a Response Message in the form of a Mode 5 Process Gain interrogation. This Response Message includes the targeting aircraft's identification number that was received in the Target Message.

Reverse Mode 5 capability is added to the transponder by an update software OFP (Operational Flight Program). This is a software and firmware update only. FIG. 1 shows a top level block diagram of the Reverse Mode 5-capable transponder. For Reverse Mode 5 operation the transponder will utilize the existing hardware interfaces for control, status and GPS information. However, the platform interface must be modified to include the signals shown on the left of Diagram 1. If Reverse Mode 5 is enabled and the platform locks onto a target area, the attack coordinates, effects radius and aircraft identification number are sent to the transponder over the platform interface. If a response is received from a ground responder, the transponder will use the platform aircraft's interface to communicate a “don't shoot” message to the platform mission computer. For this development, demonstration, and flight test effort the platform's Ethernet interface was modified to implement the Reverse Mode 5 functionality.

The hardware of the Reverse Mode 5-capable Transponder is not modified from the APX-123. This allows integration onto current aircraft with a Mode 5 Transponder without having to rewire the platform, add additional antennas, or occupy a weapon station to add this capability.

While the present invention has been described in connection with one embodiment, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways, In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

What is claimed is:

1. A friend identification method comprising:
targeting a specific ground location from a platform, with a weapon having a predetermined effects radius;
triggering an onboard transponder;
issuing an encrypted warning message from said platform, containing information identifying said platform and information about said target location to any responder near said location;
receiving the warning message at said responder;
decrypting the warning message at said responder;
determining, at said responder, whether said target location is within said predetermined effects radius from the responder, and, if so,
issuing from said responder to said transponder a response message to the warning message, said response identifying the responder as friendly.

2. The invention of claim 1, wherein the onboard transponder is a Mark XIIA Mode 5 transponder and the encrypted warning message is a reverse Mode 5 message.

3. The invention of claim 2, wherein said reverse Mode 5 message contains information about said predetermined effects radius.

4. The invention of claim wherein said response message contains formation including an identification of said platform.
